(19) United States
(12) Patent Application Publication
(10) Pub. No.: US 2009/0247914 A1
(43) Pub. Date: Oct. 1, 2009

(54) Vibration machine for physical fitness

(76) Inventors: Kuei-Hsien Shen, Hsichih City (TW); Chinn-Chann Chiang, Hsichih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,489

(22) Filed: Apr. 1, 2008

(51) Int. Cl. A61H 1/00

(52) U.S. Cl. 601/49

(57) ABSTRACT

A vibration machine includes a base, a vibration plate suspending above the base for supporting a person, a supplementary shaft fixedly mounted on the center of the bottom side of the vibration plate, a plurality of axle housing elements fixedly mounted on the base around the supplementary shaft, a plurality of spring members vertically connected between the vibration plate and the base and spaced around the axle housing elements, and a DC linear motor surrounded by the axle housing elements on the base for moving the supplementary shaft and the vibration plate alternatively up and down relative to the base.

### BACKGROUND OF THE INVENTION

1. Field of the Invention

The present invention relates to physical fitness machines and more particularly, to a vibration machine for physical fitness that uses a DC linear motor to reciprocate a vibration plate on which the user stands.

2. Description of the Related Art

FIG. 1 is a schematic sectional view of a conventional vibration machine for physical fitness. As illustrated, the vibration machine comprises a hollow base 10, a vibration plate 14 suspending above the top open side of the base 10, a plurality of spring members 15 connected between the vibration plate 14 and the bottom wall of the base 10, a rotary motor 11 mounted inside the base 10, a cam 13 fastened to the output shaft 12 of the rotary motor 11 and rotatable by the rotary motor 11 to move the vibration plate 14 up and down relative to the base 10. When the user is standing on the vibration plate 14, the vibration frequency of the vibration plate 14 acts with the vibration frequency of the internal organs of the user to produce a resonance effect, strengthening the physical status of the user. However, this design of vibration machine has drawbacks as follows:
1. Friction between the cam 13 and the vibration plate 14 causes the machine to wear quickly with use. Further, the heavy weight of the user enhances the friction between the cam 13 and the vibration plate 14, shortening the service life of the machine.
2. The vibration machine causes noises during operation.
3. The vibration frequency of the vibration plate 14 of the vibration machine is not adjustable subject to the vibration frequency of the internal organs of a different user. The optimal vibration frequency and vibration amplitude of the vibration plate 14 are within 3 Hz˜50 Hz and 5 mm˜110 mm respectively. However, the adjustment range of the revolving speed of the cam 13 is limited. This design of vibration machine does not allow every user to adjust the vibration amplitude of the vibration plate 14 subject to one's individual requirements.

### SUMMARY OF THE INVENTION

The present invention has been accomplished under the circumstances in view. It is the main object of the present invention to provide a vibration machine for physical fitness that eliminates friction damage and operating noise.

To achieve this and other objects of the present invention, the vibration machine comprises a base, a vibration plate suspending above the base for supporting a person, a supplementary shaft fixedly mounted on the center of the bottom side of the vibration plate, a plurality of axle housing elements fixedly mounted in the base around the supplementary shaft, a plurality of spring members vertically connected between the vibration plate and the base and spaced around the axle housing elements, and a DC linear motor surrounded by the axle housing elements inside the base for moving the supplementary shaft and the vibration plate alternatively up and down relative to the base. The DC linear motor comprises a stator affixed to the base and a mover connected to the supplementary shaft and, movable vertically relative to the stator. The stator has wound thereon a stator winding that produces a magnetic field when electrically connected. The mover comprises an axle tube, and a plurality of rare earth type magnetic steel members surrounding the axle tube and providing a magnetic field that acts upon the magnetic field produced by the stator winding.

### BRIEF DESCRIPTION OF THE DRAWINGS

FIG. 1 is a schematic sectional view of a vibration machine for physical fitness according to the prior art.

FIG. 2 is an elevational view of a vibration machine for physical fitness according to the present invention.

FIG. 3 is an exploded view of a part of the vibration machine for physical fitness according to the present invention.

FIG. 4 is a schematic sectional view of the present invention, showing the vibration plate lifted.

FIG. 5 is similar to FIG. 4 but showing the vibration plate lowered.

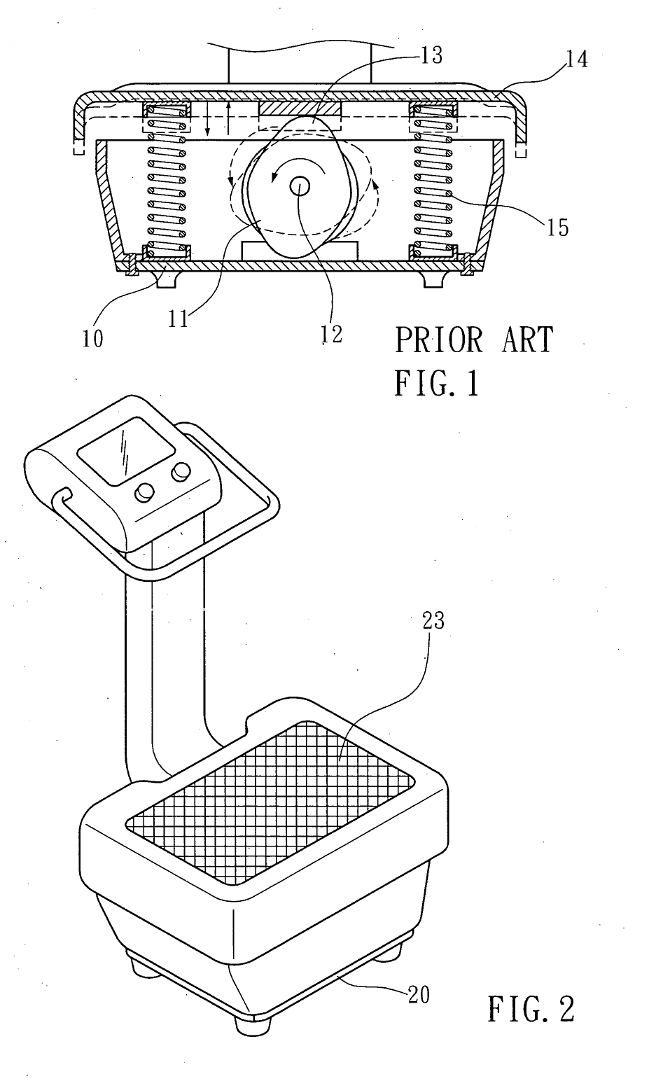

### DETAILED DESCRIPTION OF THE PREFERRED EMBODIMENT

Referring to FIGS. 2˜5, a vibration machine in accordance with the present invention is shown comprising a base 20, a vibration plate 23 suspending above the base 20, axle housing elements 21 fixedly mounted in the base 20, a supplementary shaft 24 fixedly mounted on the center of the bottom side of the vibration plate 23, and a DC linear motor 30 surrounded by the axle housing elements 21 on the base 20 and adapted for moving the vibration plate 23 alternatively up and down relative to the base 20. The DC linear motor 30 is comprised of a stator 31 and a mover 32. The stator 31 has wound thereon a stator winding 33. The mover 32 comprises an axle tube 35 and a plurality of rare earth type magnetic steel members 34 surrounding the axle tube 35. When a direct current is provided to the stator winding 33, the stator winding 33 is caused to produce a magnetic field. Changing the direction of the positive and negative poles of the direct current relatively changes the direction of the magnetic field. The strength of the magnetic field depends on the magnitude of the direct current. The variable magnetic field produced by the stator winding 33 acts against the permanent magnetic field of the rare earth type magnetic steel members 34, thereby moving the mover 32. Therefore, the DC linear motor 30 is controllable to move the supplementary shaft 24 and the vibration plate 23 alternatively up and down.

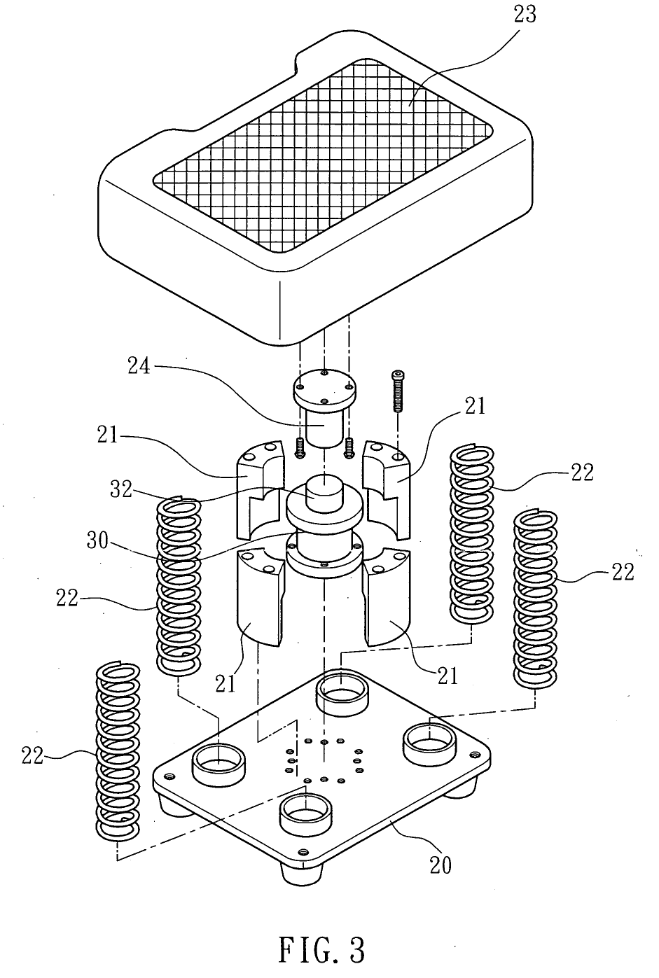

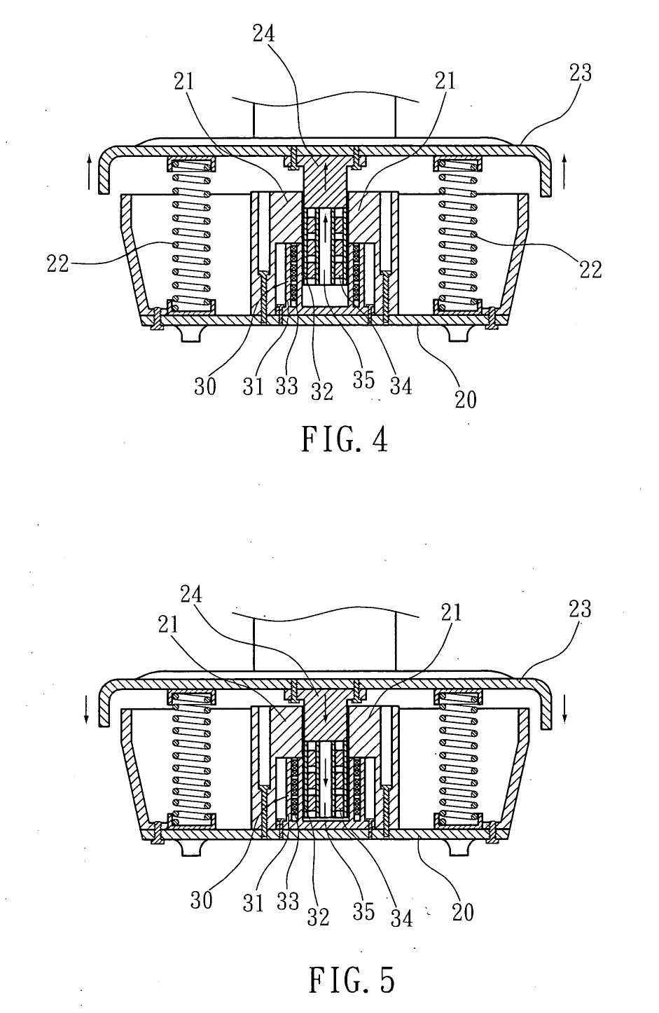

Referring to FIGS. 3 and 4 again, the vibration machine further comprises a plurality of spring members 22 vertically connected between the vibration plate 23 and the base 20. The spring members 22 support the vibration plate 23 and the load (the body weight of the person standing on the vibration plate), keeping the vibration plate 23 in balance.

Referring to FIGS. 4 and 5, when electrical current is provided to the stator winding 33 to produce a magnetic field, the magnetic field of the stator 31 acts upon the magnetic field of the mover 32, causing the mover 32 to move up and down, and therefore the vibration plate 23 is vibrated in vertical direction.

The vibration machine of the present invention has the following advantages and features:
1. The axle housing elements 21 keep vertical movement of the mover 32 and the supplementary shaft 24 in course, and therefore the vibration plate 23 is constantly maintained in balance.
2. The mover 32 and the stator 31 do not touch each other during operation of the vibration machine, avoiding friction damage.
3. The mover 32, the supplementary shaft 24 and the vibration plate 23 are fixedly connected together for synchronous movement without friction, eliminating noise during operation of the vibration machine.
4. The spring members 22 support the weight of the vibration plate 23 and supplementary shaft 24 as well as the body weight of the user standing on the vibration plate 23, and therefore the DC linear motor 30 can easily reciprocate the vibration plate 23 and supplementary shaft 24 and the user standing on the vibration plate 23 by means of overcoming the tension force of the spring members 22.
5. In conclusion, the mover 32 of the DC linear motor 30 directly moves the vibration plate 23 and the supplementary shaft 24 without friction, eliminating noise.

Although particular embodiment of the inventions have been described in detail for purposes of illustration, various modifications and enhancements may be made without departing from the spirit and scope of the invention. Accordingly, the invention is not to be limited except as by the appended claims.

What the invention claimed is:

1. A vibration machine comprising a base, a vibration plate suspending above said base for supporting a person, a supplementary shaft fixedly mounted on the center of a bottom side of said vibration plate, a plurality of axle housing elements fixedly mounted on said base around said supplementary shaft, a plurality of spring members vertically connected between said vibration plate and said base and spaced around said axle housing elements, and a DC linear motor surrounded by said axle housing elements on said base and adapted for moving said supplementary shaft and said vibration plate alternatively up and down relative to said base, said DC linear motor comprising a stator affixed to said base and a mover connected to said supplementary shaft and movable vertically relative to said stator, said stator having wound thereon a stator winding that produces a magnetic field when electrically connected, said mover comprising an axle tube and a plurality of rare earth type magnetic steel members surrounding said axle tube and providing a magnetic field that acts upon the magnetic field produced by said stator winding.
